(19) United States
(12) Patent Application Publication
(10) Pub. No.: US 2018/0170563 A1
(43) Pub. Date: Jun. 21, 2018

(54) REAR PORTION OF AN AIRCRAFT COMPRISING A FUSELAGE FRAME SUPPORTING TWO PARTLY BURIED ENGINES

(71) Applicants: Airbus Operations SAS, Toulouse (FR); Airbus Operations SL, Getafe (ES)

(72) Inventors: Eric BOUCHET, AUSSONNE (FR); Esteban MARTINO-GONZALEZ, ARANJUEZ (ES); Jerome COLMAGRO, TOULOUSE (FR); Fernando INIESTA LOZANO, MADRID (ES); Julien MOULIS, LE CASTERA (FR); Antoine ABELE, TOULOUSE (FR)

(21) Appl. No.: 15/845,330

(22) Filed: Dec. 18, 2017

(30) Foreign Application Priority Data
Dec. 20, 2016 (FR) 1662918

(51) Int. Cl. B64D 27/20; B64C 1/16; B64D 27/26

(52) U.S. Cl. CPC B64D 27/20; B64D 2033/0286; B64D 27/26; B64C 1/16

(57) ABSTRACT

In order to reduce the congestion of the attachment means for aircraft engines in a secondary vein, a first fuselage frame has two side portions for supporting the engine, each associated with one of the two partly buried side engines, these portions being curved inwards so as to surround and follow the profile of the outer shroud of an intermediate case. The side portion is attached on this shroud through first and second attachment arrangements spaced apart from each other circumferentially, these arrangements being configured in order to allow absorption of the forces related to the torque along a longitudinal direction of the engine.

### CROSS-REFERENCES TO RELATED APPLICATIONS

This application claims the benefit of the French patent application No. 1662918 filed on Dec. 20, 2016, the entire disclosures of which are incorporated herein by way of reference.

### TECHNICAL FIELD

The present invention relates to the field of aircraft comprising a rear portion equipped with two engines partly buried in the fuselage so as to be able to ingest a part of the boundary layer. These engines are also called engines for propulsion by ingestion of the boundary layer, or Boundary Layer Ingestion (BLI) engines. It is known that propulsion by boundary layer ingestion corresponds to ingestion by the engines of a low kinetic energy airflow circulating around the rear portion of the fuselage. This technology reduces the kinetic energy expended for propulsion together with aircraft drag, with a resulting reduction in fuel consumption.

### BACKGROUND OF THE INVENTION

Boundary layer ingestion engines are known to be mounted on the rear fuselage portion. These are, for example, two partly buried or semi-buried engines, protruding laterally from the rear fuselage portion.

These engines are conventionally mounted on the fuselage by means of suspension pylons of the type usually encountered for suspending the engines under the wings of the aircraft. Such a pylon comprises a box disposed in the secondary vein of the engine, together with voluminous engine attachments connecting the box to the engine. In particular, the dimensioning of the rear attachment is sufficiently significant to allow absorption of the forces related to the torque along the longitudinal direction of the engine. Due to this high dimensioning of the rear attachment, the fairing surrounding it presents an equally sizable congestion in the secondary vein, which causes significant drag.

A need for optimization therefore exists, aiming to reduce the drag caused by the attachment systems of engines partly buried in the fuselage.

### SUMMARY OF THE INVENTION

In order at least partly to satisfy this need, an object of the invention is a rear portion of an aircraft, including:
a fuselage comprising fuselage frames oriented in transversal planes of the rear portion of the aircraft;
two engines situated either side of a median vertical plane of the rear portion, each engine being partly buried in the fuselage so as to be able to ingest a part of the boundary layer, and comprising a fan casing prolonged rearwards by an outer shroud of an intermediate casing.

According to the invention, from among the fuselage frames, a first one has two side portions for supporting the engine disposed either side of the median vertical plane, each side portion being associated with one of the two engines and curved inwards so as to surround and follow the profile of one of the engine elements from among the fan casing and the outer shroud of one of the two engines, the side portion supporting the engine being attached to the engine element through a first and a second attachment means spaced apart from each other circumferentially, the first and second attachment means being configured in order to allow absorption of the forces related to the torque along a longitudinal direction of the engine.

The invention is therefore remarkable in that it breaks with the prior art consisting of implanting a box type of suspension pylon between a partly buried engine and the fuselage. In effect, one of the fuselage frames contributes directly here to supporting the engine, and the attachment means used to absorb the torque along the longitudinal direction of the engine are disposed on the side portion of the frame, which surrounds and follows the profile of the fan casing, or that of the outer shroud of the intermediate casing. Due to this, the potential attachment means that subsist between the rear of the engine and the fuselage are by necessity less congesting, as they are no longer dedicated to absorbing the forces linked with the torque along a longitudinal direction of the engine. Consequently, their presence in the secondary vein results in reduced drag, contributing to improving the general performance of the aircraft.

The invention also provides for the implementation of the following optional characteristics, taken in isolation or combined.

From among the fuselage frames, a second one preferably has two side portions for supporting the engine, disposed either side of the median vertical plane, each side portion being associated with one of the two engines and attached to a casing disposed at the rear of the intermediate casing:
through a third attachment means configured to allow absorption of the engine weight; and
through a fourth attachment means comprising at least one rod for absorbing the thrust forces.

The first and second attachment means preferably each comprises at least one shear pin oriented along the longitudinal direction, together with at least one clevis with the shear pin passing through it.

At least one of the first and second attachment means preferably comprises at least one shackle with the shear pin passing through it and accommodated in the clevis, the shackle preferably being disposed substantially tangentially relative to the engine element.

The first and second attachment means are preferably disposed respectively at the opposite ends of the inwardly curved portion.

Each inwardly curved side portion preferably extends over an angular sector comprised between 45 and 120°.

The first fuselage frame preferably includes a transversal armature passing though the hollow of the frame and connecting the two side portions for supporting the engine, and each side portion is attached to the associated engine element through a fifth standby attachment means, the latter only being active in the event of failure of one of the first and second attachment means.

The fourth attachment means preferably comprises a single rod for absorbing the thrust forces, or two rods for absorbing the thrust forces, disposed in a V, in parallel or in a concentric manner.

The third attachment means preferably comprises a fitting connecting the engine to the side portion of the second fuselage frame, or a plurality of rear rods connecting the engine to the side portion of the second fuselage frame, the rods being disposed in the plane of the second fuselage frame, and preferably oriented so that their axes are substantially secant at a longitudinal axis of the engine and/or substantially tangent to the fuselage.

The second fuselage frame preferably includes a reinforcing transversal armature passing through the hollow of the frame and connecting the two side portions for supporting the engine.

The two side portions of the second fuselage frame are preferably each curved inwards so as to follow the profile of a secondary vein of the engine.

The rear portion of the aircraft preferably comprises an aerodynamic cowling enclosing the third and the fourth attachment means, the aerodynamic cowling having a rear end situated upstream of a plane of outlet of a primary flow from the engine.

Alternatively, the aircraft rear portion comprises an aerodynamic cowling enclosing the fourth attachment means, together with aerodynamic cowlings each enclosing a rear rod of the third attachment means.

Finally, an object of the invention is also an aircraft comprising such a rear portion, the aircraft preferably being of a commercial type.

Other advantages and characteristics of the invention will emerge in the following non-limitative detailed description.

### BRIEF DESCRIPTION OF THE DRAWINGS

This description will be given with reference to the attached drawings, among which:

FIG. 1 shows a perspective view of an aircraft according to the invention;

FIG. 2 shows a magnified perspective view of a rear portion of the aircraft, specific to the present invention;

FIG. 2a is a perspective view of one of the two engines equipping the aircraft rear portion shown on the preceding figure;

FIGS. 3 to 5 are cutaway views along the transversal planes P3, P4 and P5 of FIG. 2;

FIG. 6 is a perspective view similar to that of FIG. 2a, with the engine equipped with means allowing its attachment to the fuselage;

FIG. 7 is a rear view of that of FIG. 6;

FIG. 8 is a top view of the aircraft rear portion, showing one of the aerodynamic fairings enclosing means of attaching the engine to the fuselage;

FIG. 9 is a perspective view of that of FIG. 8;

FIG. 10 is a perspective view similar to that of FIG. 6, presenting an embodiment alternative;

FIG. 11 is a transversal cutaway view of the fourth attachment means;

FIGS. 11a and 11b are transversal cutaway views similar to that of FIG. 11, presenting embodiment alternatives; and

FIG. 12 is a view similar to that of FIG. 9, presenting an embodiment alternative.

### DETAILED DESCRIPTION OF THE PREFERRED EMBODIMENTS

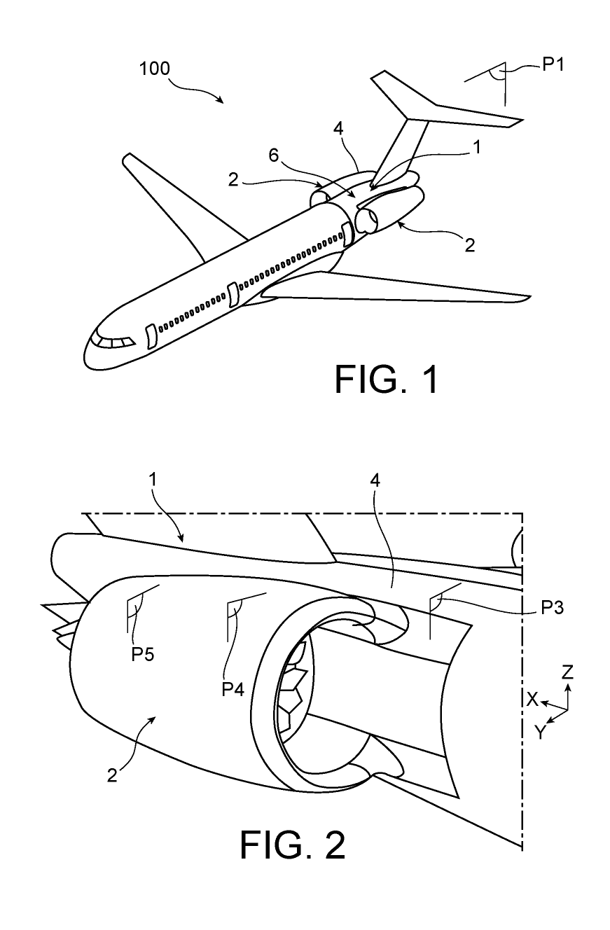

First of all, with reference to FIG. 1, an aircraft 100 of the commercial type is shown, comprising a rear portion 1 provided with two engines 2, partly buried in a fuselage 4, embodied from fuselage frames 6, oriented parallel in transversal planes of the aircraft, and covered with an outer fuselage skin. The two engines 2, capable of ingesting a part of the boundary layer of air circulating over the fuselage, are situated laterally on the fuselage, either side of a median vertical plane P1 of the rear portion 1.

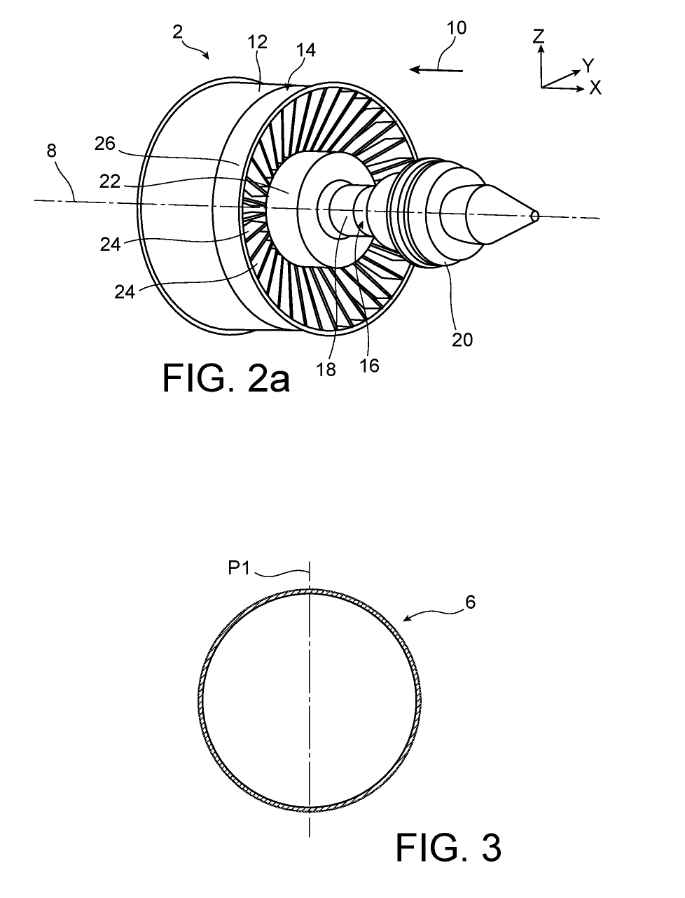

FIGS. 2 and 2a show one of the two engines 2, it being specified that since they are both of an identical or similar design, only one of them will be described below.

The engine 2 here is a turbofan, centered on a longitudinal axis 8. In this regard, it is noted that in the continuation of the description, the terms “front” and “rear” should be considered in relation to a direction of propulsion 10 of the aircraft further to the thrust generated by the engines 2, while the terms “upstream” and “downstream” should be considered in relation to a direction opposite to the direction 10. Furthermore, by convention, the direction X corresponds to the longitudinal direction of the turbofan 2, parallel to the longitudinal axis 8. On the other hand, the direction Y corresponds to the direction oriented transversally relative to the engine 2, while the direction Z corresponds to the vertical direction or that of the height. These three directions X, Y and Z are orthogonal to each other and form a direct trihedral.

The turbofan 2 with propulsion by boundary layer ingestion comprises, from front to rear, a fan surrounded by a fan casing 12, an intermediate casing 14 and a gas generator 16 enclosed in a central casing 18, prolonged rearwards in turn by a gas ejection casing 20.

The intermediate casing 14 comprises a hub 22 centered on the axis 8, together with an outer shroud 26 situated in the downstream continuation of the fan casing 12. Structural arms 24, radially oriented, connect the hub 22 to the outer shroud 26. These structural arms are also called Outlet Guide Vanes (OGV). In addition to their structural function, they therefore serve to straighten the secondary airflow inside a secondary vein 28 of the turbofan.

With reference now to FIGS. 3 to 5, the specific principle of the invention will be described, aiming for an optimized installation of the engines 2 on the fuselage. For this installation, it is planned to use the fuselage frames judiciously, which directly support the two engines.

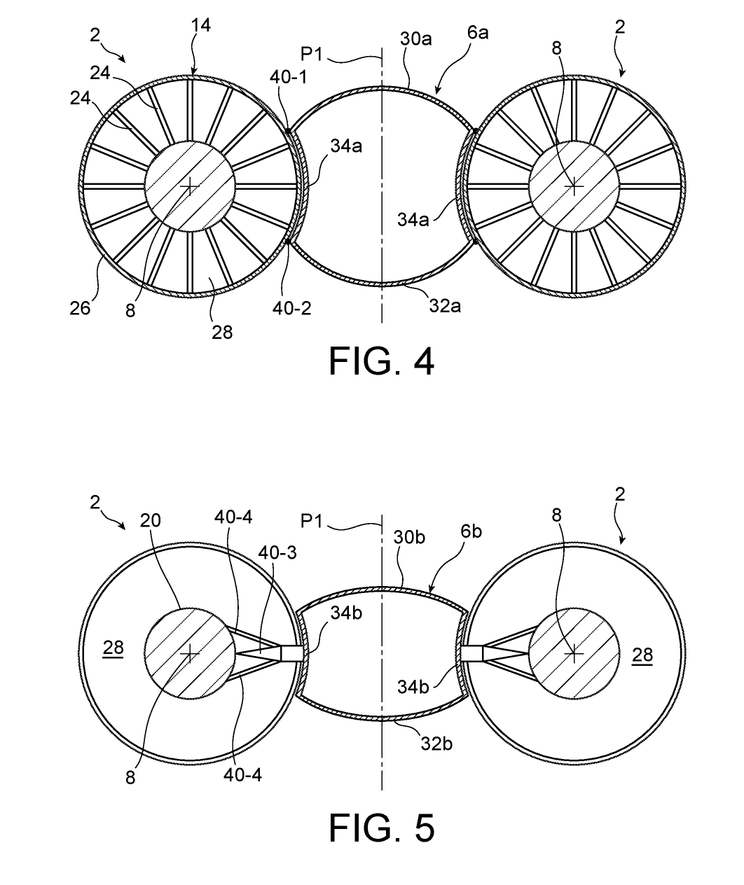

FIG. 3 shows one of the fuselage frames 6 of the rear portion of the aircraft, situated at the front of this portion. This frame 6 has a regular shape of the circular or ovalized type, such as conventionally encountered in the prior art. However, the two fuselage frames 6a, 6b shown on FIGS. 4 and 5 are two frames situated more to the rear, each contributing to supporting the engines. Furthermore, they respectively define two transversal planes for absorbing forces between the fuselage and each engine.

The main plane for absorbing forces is that defined by the first fuselage frame 6a, shown on FIG. 4. This transversal plane passes through the intermediate casing 14, and, in particular, the arms 24 together with the outer shroud 26. Alternatively, the frame 6a could be disposed in a plane further upstream passing through the fan casing 12, without being outside the framework of the invention. However, the fact of placing the first fuselage frame 6a in the plane of the intermediate casing 14 makes it possible to benefit from a healthier absorption of the forces that transit through the structural arms 24.

The first frame 6a has an upper portion 30a and a lower portion 32a of conventional shapes, domed respectively upwards and downwards. In order to connect these two portions, the first frame 6a includes two side portions 34a for supporting the engine, each side portion 34a being dedicated to supporting one of the engines 2. Given that the cooperation between each side portion 34a and its engine 2 is the same for the two engines, only one of the portions will be described below. However, it should be understood that the two side portions 34a are symmetrical relative to the median vertical plane P1, as are the means allowing the engines to be attached to these portions.

Each side portion for supporting the engine 34a has a shape curved inwards so as to surround a portion of the outer shroud 26, while following its geometric profile. For an optimized installation, the side portion 34a is situated as close as possible to the outer surface of the shroud 26, it being possible to adopt a spacing distance of only a few centimeters.

At the opposite ends of the supporting side portion, a first means 40-1 and a second means 40-2 of attaching the side portion 34a to the outer shroud 26 are respectively provided. These two means, spaced apart from each other circumferentially, are configured to allow absorption of the forces related to the torque along the longitudinal direction X of the engine.

Due to their implantation at a large diameter shroud, especially when the engine bypass ratio is high, the two attachment means 40-1, 40-2 can be widely spaced apart from each other and consequently form a sizable lever arm. This makes it possible to reduce the intensity of the forces transiting through these means, resulting in a reduction in weight and congestion. In order to space these two attachment means 40-1, 40-2 as widely apart as possible, the supporting side portion 34a can be extended over an angular sector comprised between 45 and 120°, and centered on the axis 8. More preferably, this angular sector is near 90°.

Furthermore, the invention no longer implements box type suspension pylons, which makes it possible to bring the engine as close as possible to the fuselage frames, and to reduce the cantilever in consequence. The forces transiting through the attachments are also advantageously diminished due to this reduction of the cantilever, here also with a resulting reduction of the overall mass.

Likewise, the first and second attachment means 40-1, 40-2 used to absorb the torque along the longitudinal direction X are disposed on the outer shroud 26 of the intermediate casing, and no longer at the rear in the secondary vein as in the prior art. The other attachment means existing between the rear of the engine and the fuselage, which will be described below, of necessity then have a lower congestion. Their presence in the secondary vein 28 therefore brings about reduced drag, contributing to improving the overall performance of the aircraft.

The secondary force absorption plane is that defined by the second fuselage frame 6b, shown on FIG. 5 and situated at the rear of the first frame 6a. This transversal plane preferably passes through the gas ejection casing 20, or a rear portion of the central casing. The second frame 6b has an upper portion 30b and a lower portion 32b of conventional shapes, domed respectively upwards and downwards. In order to connect these two portions, the second frame 6b includes two side portions 34b for supporting the engine, each side portion 34b being dedicated to supporting one of the engines 2. Here again, given that the cooperation between each side portion 34b and its engine 2 is the same for the two engines, only one of the portions will be described below. However, it should be understood that the two side portions 34b are symmetrical relative to the median vertical plane P1, as are the means allowing the engines to be attached to these portions

Each side portion for supporting the engine 34b has a shape curved inwards so as to follow the aerodynamic profile of the secondary vein 28. Consequently, the spacing distance between the side portion 34b and the ejection casing 20 is greater than the distance between the side portion 34a and the outer shroud 26 of the intermediate casing.

In order to connect the side portion 34b to the ejection casing 20, a third attachment means 40-3 is provided, situated in the plane of the second fuselage frame 6b. This third means 40-3 is configured to allow absorption of at least the weight of the engine, and also potentially of forces other than those of gravity, as will be described below. As previously mentioned, since the forces to be absorbed on this rear absorption plane are reduced, the congestion of the third attachment means 40-3 remains low. Furthermore, it can be placed axially towards the rear compared with the prior art, in a zone facilitating the management of the risk of rupture of the turbine blades, also known by the name risk of “Uncontained Engine Rotor Failure” (UERF).

The side portion 34b furthermore supports an attachment means 40-4, which comprises at least one rod for absorbing thrust forces along the direction X.

The first and second fuselage frames 6a, 6b that have been described above, of an overall arched shape due to the inwardly curved side walls, can be made from a single piece, or by means of several parts secured to each other.

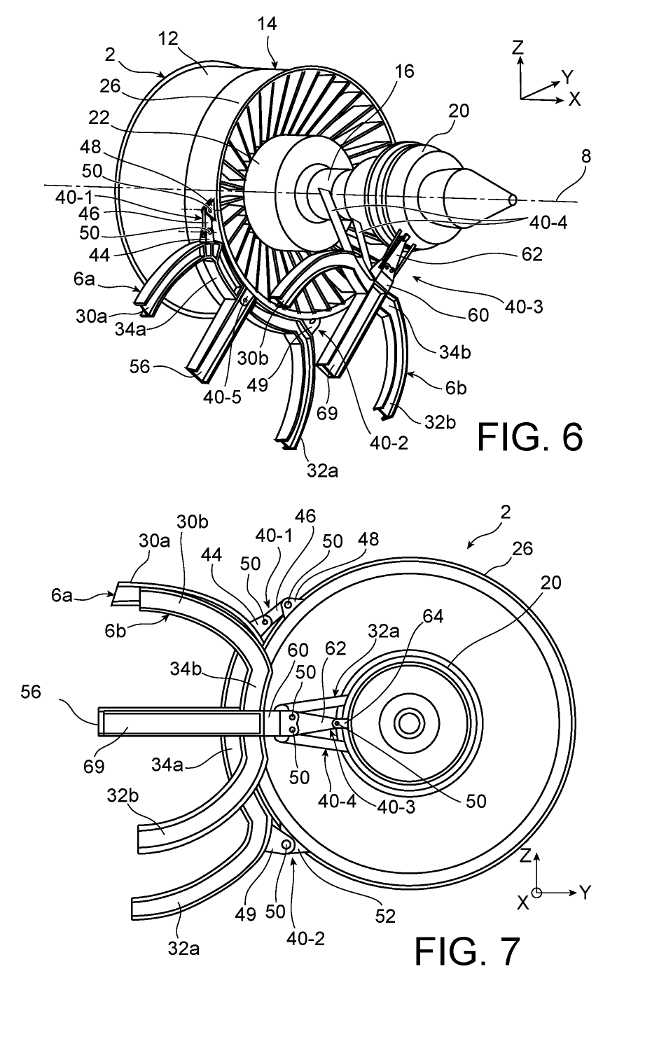

FIGS. 6 and 7 show embodiment examples of the abovementioned attachment means.

First of all, with regard to the first attachment means 40-1, it comprises a first clevis 44 integral with the high end of the side portion 34a, on which the end of a shackle or tie rod 46 is hinged. The other end of this shackle 46 is hinged on a second clevis 48 integral with the outer shroud 26 of the intermediate casing. Shear pins 50 oriented along the direction X allow the shackle 46 to be connected to the two devises 44, 48. Furthermore, the shackle 46 is preferably oriented substantially tangentially relative to the outer shroud 26. The shear pins 50 described above are preferably ball-jointed, just like those that will be mentioned below.

The second attachment means 40-2, in turn, includes a clevis 49 integral with the low end of the side portion 34a, and hinged on a fitting 52 of the outer shroud 26 through a shear pin 50 oriented along the direction X.

In the embodiment shown on FIGS. 6 and 7, the frame 6a incorporates a safety function called “Fail Safe” by providing a straight transversal armature 56 passing through the hollow of the frame. This straight armature 56, preferably situated in a median plane of the engine 2, connects the two side portions 34a. Furthermore, on each end of this armature, at the associated side portion 34a, a standby fifth attachment means 40-5 is provided between the frame 6a and the engine. This fifth attachment means 40-5 is disposed between the two means 40-1, 40-2 and attached to the outer shroud 26. It is also embodied by means of one or more shear pins, but which are mounted with play so that this fifth means 40-5 is only active in the event of failure of one of the first and second attachment means, in order, with the remaining means, to allow absorption of the torque along the direction X.

In order to manufacture the frame 6a, only half of which is visible on FIGS. 6 and 7, three parts can be attached to each other, namely an upper part and a lower part, connected by the armature 56. Each of the lower and upper parts then includes, in addition to the upper portion 30a/the lower portion 32a, a half-length of each of the side portions 34a. However, this concept of a frame in three parts is only given as an example. In effect, a one piece frame could also be proposed, or a frame in two parts.

With regard to the second fuselage frame 6b, its third attachment means 40-3 is connected centered on the side portion 34b, along the circumferential direction, by means of a first fitting 60 integral with this portion. This first fitting 60 is connected to a second triangular fitting 62 through shear pins 50 oriented along the direction X. The second fitting has an apex that cooperates with a clevis 64 of the ejection casing 20 through another shear pin 50 also oriented along the direction X. The two fittings 60, 62 fall within the plane defined by the second fuselage frame 6b.

Still in this same embodiment, the fourth attachment means 40-4 is embodied by means of two rods for absorbing the thrust forces, arranged in a V, symmetrically in relation to a diametrical plane of the engine. One of the ends of the rods is hinged on the first fitting 60, while the other end is hinged further forward on the central casing 18 or the hub 22 of the intermediate casing.

The first fitting 60 is situated in the lateral extension of a reinforcing transversal armature 69 of the second fuselage frame 6b. This armature 69, situated in the same median plane as the armature 56 of the first frame 6a, passes through the hollow of the frame 6b and connects the two side portions 34b.

In this configuration, the four attachment means 40-1 to 40-4 constitute a system of isostatic absorption of the forces between the fuselage and the engine. The thrust forces along the direction X are absorbed by the rods 40-4, while the forces along the direction Z are absorbed by the third means 40-3, together with the second means 40-2. Furthermore, the forces along the direction Y are absorbed by the fourth means 40-4 together with the second means 40-2. The forces connected with the torque along the direction X are absorbed jointly by the first and second means 40-1, 40-2, while the forces connected with the torque along the direction Z and with the torque along the direction Y are jointly absorbed by the second and fourth means 40-2, 40-4.

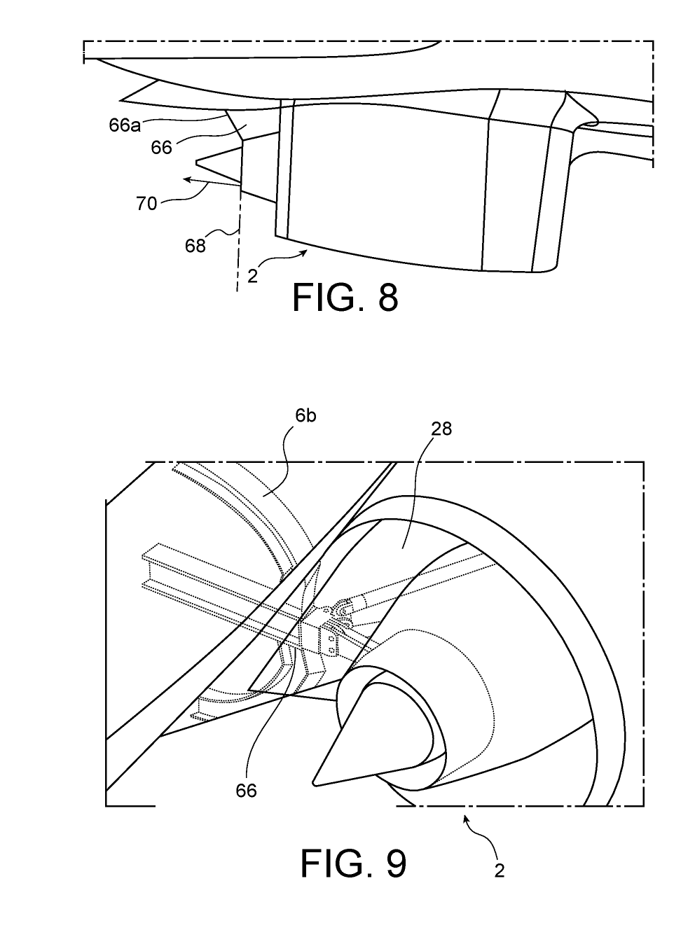

FIGS. 8 and 9 show that the same aerodynamic cowling 66, also called aerodynamic fairing, encloses the two attachment means 40-3, 40-4 inside the secondary vein 28. The aerodynamic cowling 66 has a rear end 66a situated upstream of a plane 68 of outlet of a primary flow 70 from the engine. In other words, the need to provide an APF type of fairing at the primary flow outlet no longer exists, which, in addition to reducing drag, reduces overall mass.

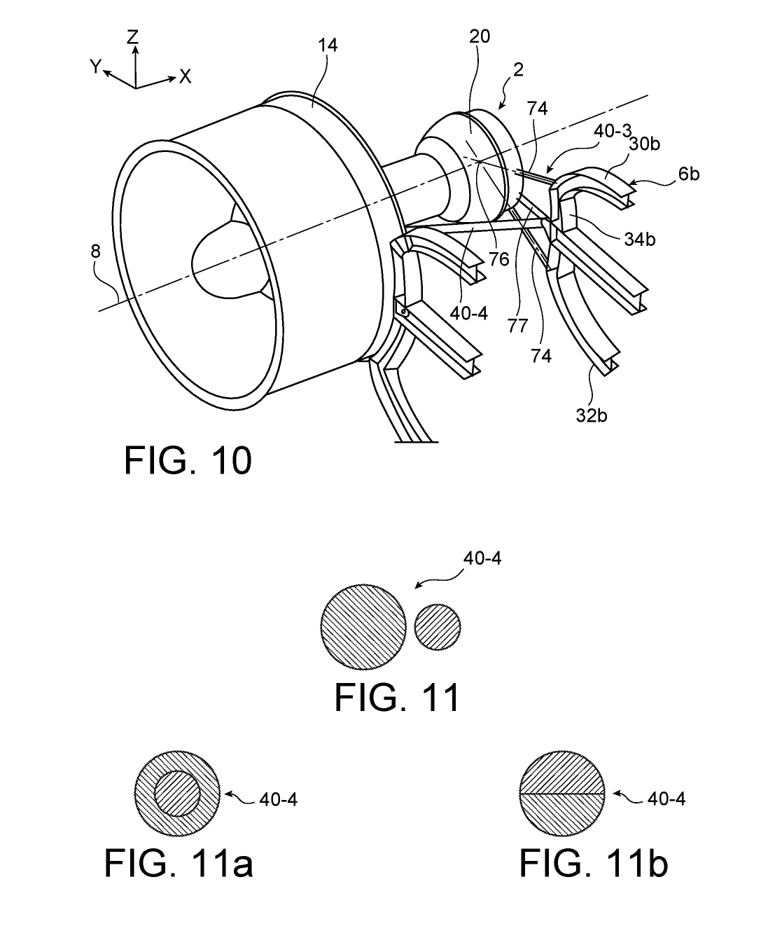

FIG. 10 shows an embodiment alternative in which the third means 40-3 includes a plurality of rear rods 74 connecting the engine to the side portion 34b of the second frame 6b. More precisely, these are two rods 74 disposed symmetrically relative to a diametrical plane of the engine, with one of the ends hinged on the ejection casing 20 and the other end hinged on an end of the side portion 34b. These rods 74, disposed in the plane of the frame 6b, are preferably oriented so that their axes are substantially secant at a point 76 on a longitudinal axis 8. Furthermore, for better introduction of the forces into frame 6b, these axes are substantially tangent to the fuselage, and more precisely tangent to the upper and lower portions 30b, 32b of the frame 6b.

Optionally, a third fail safe rod 77 can be provided in the same plane as the two others, and also in the plane of symmetry of these two rods 74. This fail safe rod 77 is disposed so as to be active only in the event of failure of one of the two rear rods 74.

The same embodiment of FIG. 10 shows that the fourth means 40-4 only comprises a single rod for absorbing the thrust forces, which limits the congestion of this means in the secondary vein. Alternatively as schematized on FIG. 11, it could be two rods close together, disposed in parallel. A solution with concentric rods., such as that shown on FIG. 11a, can also be envisaged, likewise a solution where the rod is embodied by two half rods as shown on FIG. 11b. In these solutions of FIGS. 11 to 11b, the single rod is doubled for safety reasons in order to confer a “Fail Safe” function on the arrangement.

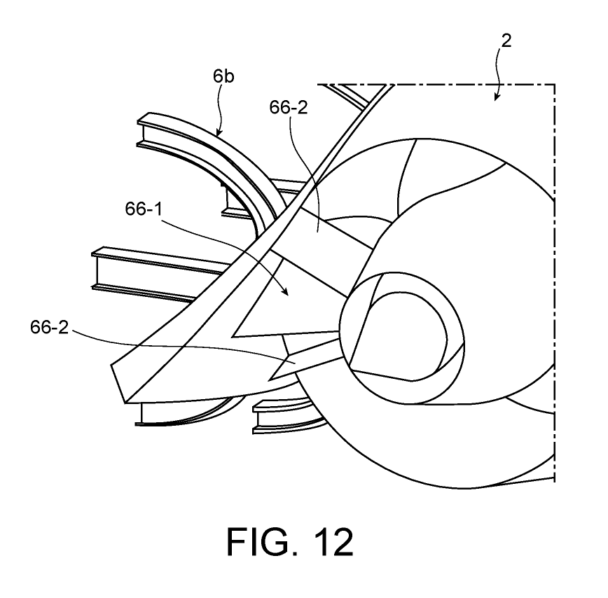

Finally, FIG. 12 shows that independent aerodynamic cowlings can be implemented instead of fairing the third and fourth means with the same cowling. An aerodynamic cowling 66-1 consequently encloses the fourth attachment means, while two other aerodynamic cowlings 66-2 each enclose one of the two rear rods of the third attachment means.

Of course, various modifications can be brought by the person skilled in the art to the invention that has just been described, only as non-limitative examples. In particular, the embodiments that have been described above are not exclusive from each other, but can on the contrary be combined with each other. Furthermore, for fail safety reasons, each structural element described above can be doubled, namely embodied by two distinct elements plated one against the other so that in the event of failure of one, the other can allow the transmission of forces for at least a determined period. This principle can be applied for example to the first and second fuselage frames.

While at least one exemplary embodiment of the present invention(s) is disclosed herein, it should be understood that modifications, substitutions and alternatives may be apparent to one of ordinary skill in the art and can be made without departing from the scope of this disclosure. This disclosure is intended to cover any adaptations or variations of the exemplary embodiment(s). In addition, in this disclosure, the terms “comprise” or “comprising” do not exclude other elements or steps, the terms “a” or “one” do not exclude a plural number, and the term “or” means either or both. Furthermore, characteristics or steps which have been described may also be used in combination with other characteristics or steps and in any order unless the disclosure or context suggests otherwise. This disclosure hereby incorporates by reference the complete disclosure of any patent or application from which it claims benefit or priority.

1. A rear portion of an aircraft comprising:
a fuselage comprising fuselage frames oriented in transversal planes of the rear portion of the aircraft;
two engines situated on either side of a median vertical plane of the rear portion, each engine being partly buried in the fuselage to be configured to ingest a part of a boundary layer of airflow along the fuselage, and comprising a fan casing prolonged rearwards by an outer shroud of an intermediate casing;
wherein, from among the fuselage frames, a first frame has two side portions for supporting the engine disposed either side of the median vertical plane,
each side portion being associated with one of the two engines and curved inwards to surround and follow a profile of one of the fan casing and the outer shroud of one of the two engines,
the side portion for supporting the engine being attached to the engine element through a first and a second attachment means spaced apart from each other circumferentially,
the first and second attachment means being configured to allow absorption of the forces related to the torque along a longitudinal direction of the engine.

2. The rear portion of an aircraft as claimed in claim 1, wherein, from among the fuselage frames, a second frame has two side portions for supporting the engine, disposed on either side of the median vertical plane), each side portion being associated with one of the two engines and attached to a casing disposed at the rear of the intermediate casing:
through a third attachment means configured to allow absorption of the engine weight; and
through a fourth attachment means comprising at least one rod for absorbing the thrust forces.

3. The rear portion of an aircraft as claimed in claim 1, wherein the first and second attachment means each comprises at least one shear pin oriented along the longitudinal direction, together with at least one clevis with the shear pin passing through it.

4. The rear portion of an aircraft as claimed in claim 3, wherein at least one of the first and second attachment means comprises at least one shackle with the shear pin passing through the shackle and accommodated in the clevis, said shackle preferably being disposed substantially tangentially relative to said engine element.

5. The rear portion of an aircraft as claimed in claim 1, wherein first and second attachment means are disposed respectively at opposite ends of the inwardly curved portion.

6. The rear portion of an aircraft as claimed in claim 1, wherein each inwardly curved side portion extends over an angular sector comprised between 45 and 120°.

7. The rear portion of an aircraft as claimed in claim 1, wherein the first fuselage frame includes a transversal armature passing though a hollow of the frame and connecting the two side portions for supporting the engine, and wherein each side portion is attached to said associated engine element through a fifth standby attachment means, the latter only being active in the event of failure of one of the first and second attachment means.

8. The rear portion of an aircraft as claimed in claim 2, wherein the fourth attachment means comprises a single rod for absorbing the thrust forces.

9. The rear portion of an aircraft as claimed in claim 2, wherein the fourth attachment means comprises two rods for absorbing the thrust forces.

10. The rear portion of an aircraft as claimed in claim 9, wherein the two rods are disposed in a V, in parallel or in a concentric manner.

11. The rear portion of an aircraft as claimed in claim 2, wherein the third attachment means comprises a fitting connecting the engine to the side portion of the second fuselage frame.

12. The rear portion of an aircraft as claimed in claim 2, wherein the third attachment means comprises a plurality of rear rods connecting the engine to the side portion of the second fuselage frame, the rods being disposed in the plane of the second fuselage frame.

13. The rear portion of an aircraft as claimed in claim 12, wherein the rods are oriented so that their axes are substantially secant at a longitudinal axis of the engine.

14. The rear portion of an aircraft as claimed in claim 12, wherein the rods are oriented so that their axes are substantially tangent to said fuselage.

15. The rear portion of an aircraft as claimed in claim 2, wherein the second fuselage frame includes a reinforcing transversal armature passing through a hollow of the frame and connecting the two side portions for supporting the engine.

16. The rear portion of an aircraft as claimed in claim 2, wherein the two side portions of the second fuselage frame are each curved inwards so as to follow the profile of a secondary vein of the engine.

17. The rear portion of an aircraft as claimed in claim 2, further comprising an aerodynamic cowling enclosing the third and the fourth attachment means, said aerodynamic cowling having a rear end situated upstream of a plane of outlet of a primary flow from the engine.

18. The rear portion of an aircraft as claimed claim 11, further comprising an aerodynamic cowling enclosing the fourth attachment means, together with aerodynamic cowlings each enclosing a rear rod of the third attachment means.

19. An aircraft comprising a rear portion according to claim 1.
